(19) United States
(12) Patent Application Publication
(10) Pub. No.: US 2020/0168406 A1
(43) Pub. Date: May 28, 2020

(54) CAPACITOR AND METHOD FOR PRODUCING SAME

(71) Applicant: NIPPON CHEMI-CON CORPORATION, Tokyo (JP)

(72) Inventors: Atsushi Yoshida, Tokyo (JP); Kazuhiro Nagahara, Tokyo (JP)

(73) Assignee: NIPPON CHEMI-CON CORPORATION, Tokyo (JP)

(21) Appl. No.: 16/638,253

(22) PCT Filed: Aug. 14, 2018
(86) PCT No.: PCT/JP2018/030275

§ 371 Date: Feb. 11, 2020

(30) Foreign Application Priority Data
Aug. 17, 2017 (JP) 2017-157458

(51) Int. Cl. H01G 9/10; H01G 9/008; H01G 9/15; H01G 9/055; H01G 9/045; H01G 9/042

(52) U.S. Cl. CPC H01G 9/10; H01G 9/008; H01G 9/0425; H01G 9/055; H01G 9/045; H01G 9/151

(57) ABSTRACT

An object is to suppress generation of molecular hydrogen from atomic hydrogen generated in a capacitor so as to suppress a rise in pressure of the capacitor due to the increased molecular hydrogen. A capacitor (2) includes a capacitor element (6) formed by winding an anode foil (14) and a cathode foil (16), and an outer case (4) storing the capacitor element therein. A hydrogen reaction film (22) reactive with atomic hydrogen generated in the outer case is formed on a surface of the cathode foil.

### TECHNICAL FIELD

The present disclosure relates to a capacitor including an anode foil and a cathode foil to store electricity.

### BACKGROUND ART

Regarding a capacitor such as an electrolytic capacitor, it is known that a capacitor element is fabricated by winding anode and cathode foils made of, for example, aluminum, and a separator sandwiched therebetween and that the capacitor element is impregnated with an electrolytic solution (e.g., Patent Literature 1). A capacitance C (unit: [F]) of such a capacitor is represented by Eq. (1), where S [m²] is an effective area of a surface of the anode foil facing the cathode foil, d [m] is a thickness of an oxide film formed on the surface of the anode foil, and ε is a relative permittivity of the oxide film.

C=8.854×10⁻¹²×ε·S/d (1)

### CITATION LIST

### Patent Literature

Patent Literature 1: Japanese Laid-Open Patent Publication No. 2012-89688

### SUMMARY OF INVENTION

### Technical Problem

Capacitors increased in capacitance are demanded. A first technique for increasing the capacitance is a method of increasing a thickness of an etching layer of an anode foil, i.e., a method of increasing the effective area S of Eq. (1). However, this method results in an increase in the thickness of the anode foil, so that a capacitor is increased in size. Since a reduction in size of the capacitors is demanded along with the increase in capacitance, this method is not preferable. A second technique for increasing the capacitance is a method of reducing a thickness of an oxide film of the anode foil, i.e., reducing the thickness d of Eq. (1). This method can increase the capacitance while maintaining or reducing the size of the capacitor. On the other hand, the withstand voltage of the capacitor depends on the thickness d of the oxide film of the anode foil. When the oxide film is made thinner, the withstand voltage of the anode foil is lowered, and a leakage current is increased, in accordance with an amount of reduction in the thickness of the oxide film. If the leakage current is generated, oxygen ions (O²⁻) are generated from hydroxide ions (OH⁻) present due to dissociation of water in an electrolytic solution as an anodic polarization reaction. The generated oxygen ions (O²⁻) react with aluminum of the anode foil to form an oxide film and generate electrons. Therefore, an increase in the leakage current significantly increases a quantity of generated electrons. In this case, protons (H⁺) increase at an interface between the electrolytic solution and the oxide film on the anode foil.

A reduction in the thickness of the oxide film on the anode foil increases the leakage current of the capacitor and increases the quantity of electrons generated by the anodic polarization reaction. When these electrons are transferred to the cathode foil, a cathodic polarization reaction occurs. In the cathodic polarization reaction, the transferred electrons bond to protons in the electrolytic solution existing near the cathode foil, and atomic hydrogen (H_{ad}) is generated. When two atomic hydrogens bond to each other, molecular hydrogen (H₂ gas) is generated. A reaction amount of the cathodic polarization reaction generating the molecular hydrogen increases in proportion to a reaction amount of the anodic polarization reaction corresponding to the leakage current of the capacitor in accordance with Faraday's law. Therefore, if the oxide film of the anode foil is made thinner so as to increase the capacitance C, the internal pressure of the capacitor rises in a short period of time due to an increase in the generation amount of the molecular hydrogen, which causes a problem of a shortened life of the capacitor.

Such a problem is particularly significant in middle and high voltage capacitors having a rated voltage of 400 volts or more.

Such a problem is not disclosed or suggested in Patent Literature 1. Techniques of the present disclosure focus on and solve the problem not disclosed or suggested in Patent Literature 1. Therefore, an object of the techniques of the present disclosure is to suppress generation of molecular hydrogen from atomic hydrogen generated in a capacitor so as to suppress a rise in pressure of the capacitor due to the increased molecular hydrogen.

### Solution to Problem

According to an aspect of the present disclosure, a capacitor includes a capacitor element formed by winding an anode foil and a cathode foil, and an outer case storing the capacitor element therein. A hydrogen reaction film reactive with atomic hydrogen generated in the outer case is formed on a surface of the cathode foil.

In the capacitor, the anode foil may be a middle and high voltage anode foil including tunnel-shaped pits.

In the capacitor, the hydrogen reaction film may contain titanium, and the titanium may react with the atomic hydrogen.

In the capacitor, a relationship between a withstand voltage ratio of the anode foil and a titanium adhesion amount of the cathode foil may be within a range represented by the following equation:

$$y \geq a x + 1.326 \times {1.03}^{( \frac{T - 85}{20} )} \times exp \{ ln ( \frac{L}{2000} ) \times 0.04264 \} \qquad [ Mathematical 1 ]$$

where y is the withstand voltage ratio and is a film withstand voltage per volt of rated voltage of the capacitor, x is the titanium adhesion amount, is an amount of titanium (unit: g/m²) contained in the hydrogen reaction film formed on the cathode foil per square meter, and is larger than 0, and a is −0.021 or −0.020. T is an upper limit operation temperature (unit: ° C.) of the capacitor. L is an operation time (unit: h) of the capacitor, and the operation time is the time until a pressure valve operates due to a pressure inside the outer case exceeding a predetermined pressure.

According to an aspect of the present disclosure, a method for producing a capacitor includes forming a hydrogen reaction film reactive with atomic hydrogen on a surface of a cathode foil, forming a capacitor element by winding an anode foil and the cathode foil, and storing the capacitor element in an outer case.

### Advantageous Effects of Invention

According to the techniques of the present disclosure, any of the following effects is obtained.

(1) Since the hydrogen reaction film reactive with atomic hydrogen is formed on the surface of the cathode foil, the hydrogen reaction film reacts with atomic hydrogen generated in the outer case to suppress the generation and increase of molecular hydrogen so that the rise in pressure of the capacitor can be suppressed.

(2) Since the hydrogen reaction film formed on the surface of the cathode foil suppresses a rise in pressure of the capacitor, a film withstand voltage of the anode foil can be lowered as compared to a capacitor without the hydrogen reaction film. Therefore, the capacitance C per unit facing area can be increased.

(3) Since the hydrogen reaction film formed on the surface of the cathode foil suppresses the rise in pressure of the capacitor, the operation time of the capacitor, i.e., the life of the capacitor, can be made longer as compared to a capacitor without the hydrogen reaction film.

Other objects, features, and advantages of the present disclosure will become more apparent by reference to the accompanying drawings, embodiments, and examples.

### BRIEF DESCRIPTION OF DRAWINGS

FIG. 1A is a diagram showing a capacitor according to an embodiment. FIG. 1B is an enlarged view of a region B shown in FIG. 1A.

FIG. 2 is a graph showing an example of a relationship between the durability of the capacitor and a film withstand voltage of an anode foil.

FIG. 3 is a diagram showing an example of a process of forming a hydrogen reaction film on surfaces of a cathode foil.

FIGS. 4A, 4B, and 4C are graphs showing changes in height of capacitors according to Examples and Reference Examples.

### DESCRIPTION OF EMBODIMENTS

An embodiment and examples will now be described with reference to the drawings.

### Embodiment

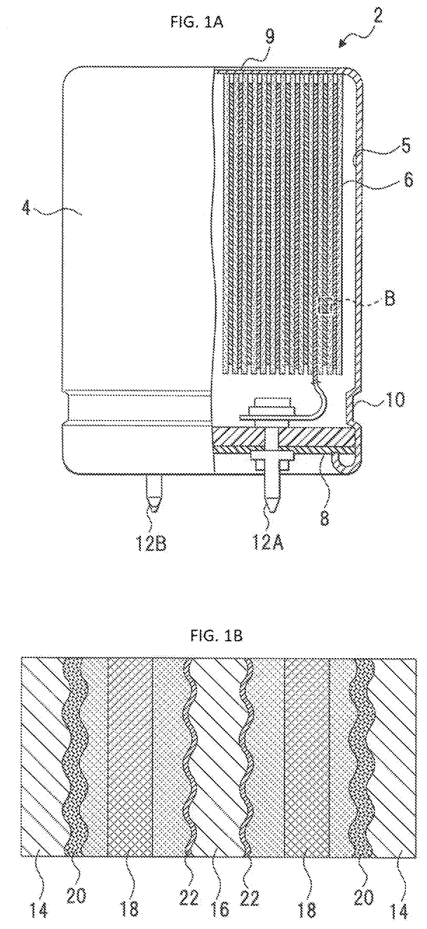

An embodiment will be described with reference to FIGS. 1A and 1B. FIG. 1A shows a capacitor according to the embodiment. In FIG. 1A, the right half of the capacitor is shown as a cut surface including the center of the capacitor so as to show an internal structure of the capacitor. FIG. 1B is an enlarged view of a region B shown in FIG. 1A.

A capacitor 2 is a capacitor having an anode foil and a cathode foil and is an aluminum electrolytic capacitor, for example. This capacitor 2 includes an outer case 4, a capacitor element 6, and a sealing body 8. The capacitor element 6 is stored in the outer case 4, and the sealing body 8 is disposed in an opening portion of the outer case 4.

The outer case 4 includes a storage part 5, and the storage part 5 stores the capacitor element 6 and an electrolytic solution (not shown). The outer case 4 has, for example, a bottomed cylindrical shape and is made of a metal such as aluminum or a hard material such as an aluminum alloy containing manganese or magnesium. The hard outer case 4 has rigidity with a crimping part 10 not loosened even in a high temperature environment so that a fixing force for fixing the sealing body 8 is maintained. A pressure valve 9 is disposed on a bottom surface of the outer case 4. When the pressure inside the outer case 4 exceeds a predetermined pressure, the pressure valve 9 is opened to prevent the capacitor 2 from bursting. When the pressure valve 9 is opened, the life of the capacitor is over.

The sealing body 8 seals the opening portion of the outer case 4. The capacitor element 6 is enclosed inside the outer case 4 by the outer case 4 and the sealing body 8. The sealing body 8 is a resin plate containing a resin such as a phenol resin or an elastic body such as rubber, for example, and blocks entry of air, moisture, etc. into the storage part 5.

The sealing body 8 includes external terminals 12A, 12B. The external terminals 12A, 12B are conductive members penetrating the sealing body 8, and inner ends of the external terminals 12A, 12B are connected to one end side of the capacitor element 6. For example, the external terminal 12A is connected to an anode foil 14 of the capacitor element 6, and the external terminal 12B is connected to a cathode foil 16. Outer ends of the external terminals 12A, 12B are projected from the outside of the sealing body 8 and are to be connected to an electric circuit on a substrate, for example. The sealing body 8 is fixed to the opening portion of the outer case 4 by a curling process for the opening portion of the outer case 4 and the crimping part 10 formed circumferentially along an outer circumferential surface of the outer case 4.

The capacitor element 6 includes the anode foil 14, the cathode foil 16, and separators 18. The anode foil 14, the cathode foil 16, and the separators 18 form a laminated body. This laminated body is wound to form the capacitor element 6. The capacitor element 6 has a columnar shape, for example. The anode foil 14 constitutes an anode of the capacitor 2, and the cathode foil 16 constitutes a cathode of the capacitor 2. Each separator 18 is disposed between the anode foil 14 and the cathode foil 16 in a sandwiched manner between the anode foil 14 and the cathode foil 16. The separators 18 are made of electrolytic paper retaining an electrolytic solution, for example, and prevent contact between the anode foil 14 and the cathode foil 16.

The anode foil 14 includes an aluminum foil, for example, and has unevenness formed by an etching process on the surface of the anode foil 14. The anode foil 14 has an oxide film 20 formed on the surface thereof by a chemical conversion treatment. The anode foil 14 is a middle and high voltage anode foil, for example, and the unevenness of the surface includes tunnel-shaped pits (holes) formed by tunnel etching. The diameter of the tunnel-shaped pits is, for example, about 1 [μm], the length of the tunnel-shaped pits is, for example, several tens of [μm], and the density of tunnel-shaped pits is, for example, 10⁵ to 10⁸ [pits/cm⁻²]. For example, the anode foil 14 has a film withstand voltage Vt of 200 volts or more due to the oxide film 20. This film withstand voltage Vt is a withstand voltage measured based on JEITA Standards EIAJ RC-2364A “Test Methods of Electrode Foil for Aluminium Electrolytic Capacitors” (revised March 1999), which is standardized by Japan Electronics and Information Technology Industries Association (JEITA).

For example, the cathode foil 16 includes an aluminum foil and has a hydrogen reaction film 22 on the surface of the cathode foil 16. The hydrogen reaction film 22 reacts with atomic hydrogen generated by protons bonding to electrons and bonds to the atomic hydrogen. For example, the hydrogen reaction film 22 takes the atomic hydrogen into the film. Since this hydrogen reaction film 22 bonds to the atomic hydrogen, bonding between atomic hydrogens is suppressed, so that generation and increase of molecular hydrogen such as hydrogen gas are suppressed. The hydrogen reaction film 22 only needs to include a member reactive with atomic hydrogen and is a member made of pure titanium, a titanium compound such as titanium nitride and titanium carbide, a titanium alloy, or a mixture thereof, for example. The hydrogen reaction film 22 is formed by a vacuum deposition method, a chemical vapor deposition method, an ion plating method, or a sputtering method, for example.

[Reduction of Film Withstand Voltage of Anode Foil 14 by Hydrogen Reaction Film 22]

Since the hydrogen reaction film 22 reacts with atomic hydrogen and suppresses the increase of molecular hydrogen as described above, the capacitor 2 can allow for generation of more atomic hydrogen than a capacitor without the hydrogen reaction film 22. Even if the thickness d of the oxide film 20 of the anode foil 14 is reduced (i.e., the film withstand voltage of the anode foil 14 is lowered) and the amount of generated atomic hydrogen is increased, the operation time of the capacitor 2 (i.e., the lifetime of the capacitor) can be maintained from the start of use of the capacitor 2 to the end of use of the capacitor 2, for example. In this case, since the thickness d of the oxide film 20 is reduced, the capacitance C of the capacitor 2 can be increased.

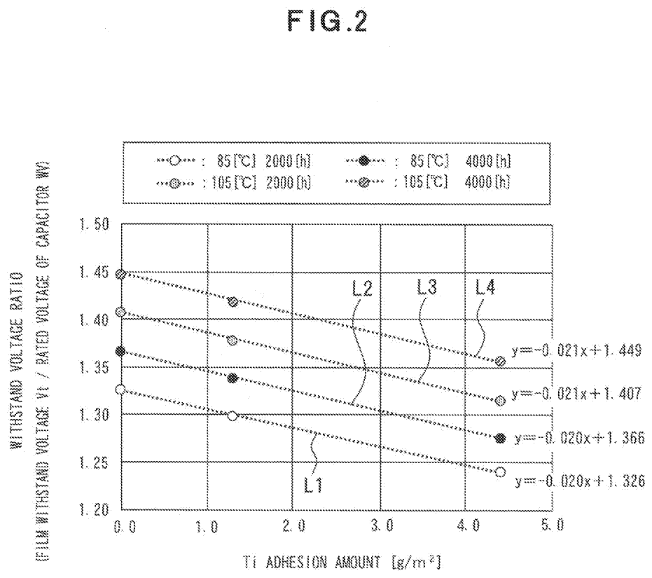

FIG. 2 shows an example of a relationship between the durability of the capacitor 2 and the film withstand voltage Vt of the anode foil 14. The durability of the capacitor 2 is represented by the time until the pressure valve 9 operates due to the pressure inside the outer case 4 exceeding the predetermined pressure. The durability of the capacitor 2 is represented by an upper limit operation temperature of the capacitor such as 85 [° C.] or 105 [° C.] and a capacitor operation time such as 2000 hours or 4000 hours, for example. A horizontal axis (X axis) of the graph shown in FIG. 2 indicates an adhesion amount (unit: [g/m²]) of titanium adhering to the cathode foil 16 per square meter (hereinafter referred to as “Ti adhesion amount”), and a vertical axis (Y axis) indicates a film withstand voltage per volt of the rated voltage (Work Voltage: WV) of the capacitor (Vt/WV) (hereinafter referred to as “withstand voltage ratio”). For the Ti adhesion amount, the titanium adhesion amount of the hydrogen reaction film 22 on both surfaces of the cathode foil 16 is taken into consideration. A straight line L1 indicates the withstand voltage ratio necessary for obtaining the operation time of 2000 hours at the upper limit operation temperature of 85 [° C.]; a straight line L2 indicates the withstand voltage ratio necessary for obtaining the operation time of 4000 hours at the upper limit operation temperature of 85 [° C.]; a straight line L3 indicates the withstand voltage ratio necessary for obtaining the operation time of 2000 hours at the upper limit operation temperature of 105 [° C.]; and a straight line L4 indicates the withstand voltage ratio necessary for obtaining the operation time of 4000 hours at the upper limit operation temperature of 105 [° C.]. Markers on the graph shown in FIG. 2 are experimental values obtained from experiments evaluating the durability of capacitors 2 different in the Ti adhesion amount and the withstand voltage ratio. The straight lines L1, L2, L3, L4 on the graph of FIG. 2 are approximate curves (linear trend, or linear approximation) drawn based on the markers on the graph. The graph of FIG. 2 is a graph created based on a new idea for evaluating the capacitors 2 different in the Ti adhesion amount and the film withstand voltage Vt. The settings of the vertical and horizontal axes of the graph shown in FIG. 2 and the data shown in this graph are useful data contributable to an advancement of the technical field of the present disclosure.

The straight lines L1, L2, L3, L4 are represented by Eqs. (2) to (5), respectively.

L1:y=−0.020×+1.326 (2)

L2:y=−0.020×+1.366 (3)

L3:y=−0.021×+1.407 (4)

L4:y=−0.021×+1.449 (5)

where y is the withstand voltage ratio, and x is the Ti adhesion amount.

The R-squared values (R²) of these straight lines L1, L2, L3, L4 are 0.998, 0.998, 0.998, 0.997, respectively. The R-square value (R²) is a decision function for an approximate function according to the least squares method. Since the R-squared values (R²) of the straight lines L1, L2, L3, L4 are all within a range of 0.997 or more and less than 1, these R-squared values (R²) represent that the approximate curves (the straight lines L1, L2, L3, L4) are reliable.

By using a coefficient a, an upper limit operation temperature T, and an operation time L, Eqs. (2) to (5) can be integrated into Eq. (6).

$$\begin{matrix}[ Mathematical 2 ] & \\ y \geq ax + 1.326 \times {1.03}^{( \frac{T - 85}{10} )} \times exp \{ ln ( \frac{L}{2000} ) \times 0.04264 \} & ( 6 )\end{matrix}$$

where a is −0.021 or −0.020.

When the withstand voltage ratio is equal to or greater than the value of the right side of Eq. (6), the capacitor 2 can obtain a durability equal to or greater than the durability set by the upper limit operation temperature T and the operation time L of Eq. (6). By using this equation (6), the film withstand voltage Vt required for the anode foil 14 can easily be determined from the upper limit operation temperature T, the operation time L and the rated voltage of the capacitor, which are related to the specifications of the capacitor 2, and the Ti adhesion amount.

Intercepts on the y axis, i.e., y-intercepts, of the straight lines L1, L2, L3, L4 represent the withstand voltage ratio required for a capacitor without the hydrogen reaction film 22. On the straight lines L1, L2, L3, L4, the withstand voltage ratio decreases as the Ti adhesion amount increases. Therefore, by forming the hydrogen reaction film 22 on the cathode foil 16, the withstand voltage ratio and the film withstand voltage Vt of the anode foil 14 can be reduced while the durability is maintained. As the withstand voltage ratio decreases, i.e., as the film withstand voltage Vt decreases, the thickness d of the oxide film 20 is reduced, and the capacitance C of the capacitor can be increased.

[Improvement of Durability of Capacitor 2 by Hydrogen Reaction Film 22]

Since the hydrogen reaction film 22 suppresses an increase in molecular hydrogen, the capacitor 2 can suppress a rise in internal pressure of the outer case 4, and the actuation timing of the pressure valve 9 formed in the outer case 4 can be delayed. In other words, the capacitor 2 can make the operation time of the capacitor 2, use of which is ended due to the actuation of the pressure valve 9, longer than the operation time of the capacitor without the hydrogen reaction film 22.

From the straight line L1 of the graph shown in FIG. 2, when the Ti adhesion amount is 0 [g/m²] and the withstand voltage ratio is 1.326, the durability of the capacitor is represented by the upper limit operation temperature of 85 [° C.] and the operation time of 2000 hours, for example. when the Ti adhesion amount is increased to 2.0 [g/m²] while this withstand voltage ratio is maintained, the durability of the capacitor is represented, from the straight line L2 of the graph, by the upper limit operation temperature of 85 [° C.] and the operation time of 4000 hours, for example. Therefore, the durability of the capacitor 2 can be improved by including the hydrogen reaction film 22.

[Analysis Method of Ti Adhesion Amount]

The Ti adhesion amount can be quantified by, for example, ICP optical emission spectroscopy (Inductively Coupled Plasma Atomic Emission Spectroscopy: ICP-AES). For example, the Ti adhesion amount is measured by the following procedure.

(1) A known area (e.g., 2.2 [cm²]) of the cathode foil 16 is cut out, and the cut-out cathode foil 16 is completely dissolved with hot concentrated sulfuric acid (e.g., 4 [ml]) to obtain a solution.
(2) The obtained solution is diluted in a measuring flask to 50 [ml] with distilled water to obtain a diluted solution of the solution.
(3) The concentration of titanium in the obtained diluted solution is quantified by an ICP optical emission spectrophotometer (e.g., model number: SPS5100, manufactured by SII Nanotechnology Inc.). Subsequently, the Ti adhesion amount of the cathode foil 16 per square meter is obtained.

[Ti Adhesion Amount]

The hydrogen reaction film 22 only needs to have a property of reacting with atomic hydrogen and is not particularly limited in terms of the minimum Ti adhesion amount. For example, the Ti adhesion amount may be an amount at a level of the detection lower limit of the ICP optical emission spectrophotometer (e.g., about 0.1 [g/m²]). The maximum Ti adhesion amount is not particularly limited. For example, the maximum Ti adhesion amount may be limited from the viewpoint of the weight increase due to the hydrogen reaction film 22 or the easiness or difficulty of winding of the cathode foil 16 due to formation of the hydrogen reaction film 22.

[Formation of Hydrogen Reaction Film 22 on Cathode Foil 16]

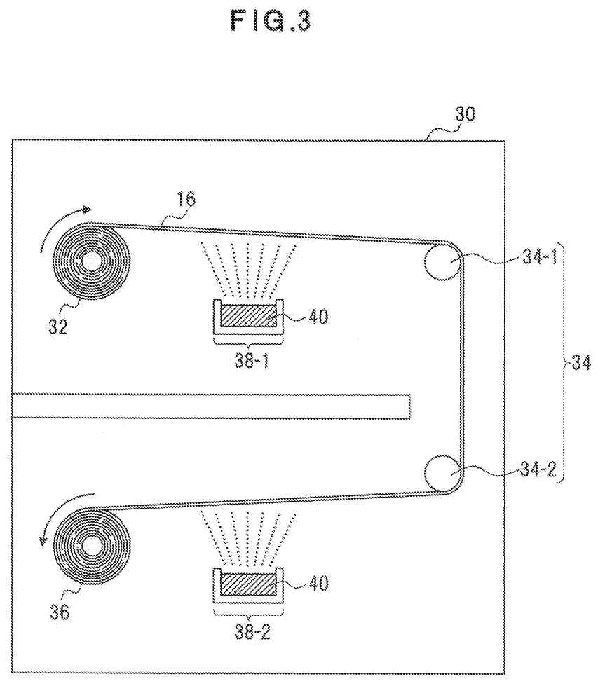

FIG. 3 shows an example of a process of forming the hydrogen reaction film 22 on the surfaces of the cathode foil 16. In the example shown in FIG. 3, the hydrogen reaction film 22 is formed by vacuum deposition using evaporation sources 38-1, 38-2. The hydrogen reaction film 22 is formed on the surfaces of the cathode foil 16. As shown in FIG. 3, a roll 32 of the cathode foil 16 is rotatably disposed in a vacuum vessel 30. The cathode foil 16 passes through a reversing part 34 and is wound around a take-up roll 36. The reversing part 34 includes reversing rolls 34-1, 24-2 and reverses the cathode foil 16 upside down. The inside of the vacuum vessel 30 is reduced in pressure to a degree of vacuum suitable for vacuum deposition (e.g., 10⁻³ to 10⁻⁴ [Pa]).

On a lower surface (first surface) of the cathode foil 16 fed from the roll 32, the hydrogen reaction film 22 is formed above an evaporation source 38-1. On a lower surface (second surface) of the cathode foil 16 reversed by the reversing part 34, the hydrogen reaction film 22 is formed above an evaporation source 38-2. The evaporation sources 38-1, 38-2 each include a heater, a high-frequency coil, a heating device such as an electron beam, and a crucible. A film forming material 40 such as titanium is disposed in the crucible, and the heating device heats the crucible to evaporate and diffuse the film forming material 40 in the crucible. The diffused film forming material 40 adheres to the surface of the cathode foil 16 to form the hydrogen reaction film 22. If a pure titanium film is formed as the hydrogen reaction film 22, the hydrogen reaction film 22 may be formed by using titanium as the film forming material 40. If a titanium nitride film is formed as the hydrogen reaction film 22, the hydrogen reaction film 22 may be formed by using titanium as the film forming material 40 while a nitrogen gas is introduced into the vacuum vessel 30. By adjusting the amount of the introduced nitrogen gas, the content rate of titanium nitride contained in the hydrogen reaction film 22 can be adjusted.

[Fabrication of Anode Foil 14]

The surface of the aluminum foil is etched, and the surface of the aluminum foil is chemically converted by a chemical conversion treatment to fabricate the anode foil 14 having the oxide film 20 formed on the surface.

[Production of Capacitor 2]

The separator 18 is disposed between the anode foil 14 on which the oxide film 20 is formed and the cathode foil 16 on which the hydrogen reaction film 22 is formed so as to form a laminated body including the anode foil 14, the separator 18, and the cathode foil 16. The laminated body is wound to fabricate the capacitor element 6. The capacitor element 6 is immersed in an electrolytic solution so that the electrolytic solution is contained in the capacitor element 6.

The capacitor element 6 is connected to the external terminals 12A, 12B on the sealing body 8, the capacitor element 6 and the sealing body 8 are stored in the storage part 5 of the outer case 4, and the sealing body 8 is fixed to the outer case 4 at the opening portion of the outer case 4 to obtain the capacitor 2.

### Functions and Effects of the Embodiment

(1) Since the hydrogen reaction film 22 bonds to atomic hydrogen, bonding between atomic hydrogens is suppressed, and the generation and increase of molecular hydrogen are suppressed. Protons in the electrolytic solution bond to electrons on the cathode foil 16 side provided with the hydrogen reaction film 22, so that the hydrogen reaction film 22 can efficiently bond to the atomic hydrogen.

(2) Since the generation and increase of molecular hydrogen are suppressed, the film withstand voltage of the anode foil 14 can be lowered to increase the capacitance C.

(3) Since the generation and increase of molecular hydrogen are suppressed, the durability of the capacitor 2 can be increased. Therefore, the capacitor 2 with high durability can be obtained.

(4) The withstand voltage ratio and the film withstand voltage Vt of the anode foil 14 can be set depending on the Ti adhesion amount. Therefore, the withstand voltage ratio and the film withstand voltage Vt of the anode foil 14 can easily be determined.

### Modifications of the Embodiment

(1) Although the hydrogen reaction film 22 is formed on both surfaces of the cathode foil 16 in the embodiment, the hydrogen reaction film 22 may be formed on one surface of the cathode foil 16. The hydrogen reaction film 22 formed on one surface of the cathode foil 16 bonds to atomic hydrogen, so that the generation and increase of molecular hydrogen can be suppressed. When the hydrogen reaction film 22 is formed on one surface of the cathode foil 16, a burden of formation of the hydrogen reaction film 22 is reduced.

(2) Although the embodiment is an example of the middle and high voltage capacitor 2 including the middle and high voltage anode foil 14, the capacitor 2 may be the low voltage capacitor 2. For the middle and high voltage capacitor 2 used at a higher voltage than the low voltage capacitor 2, handling of combustible hydrogen is important. However, when the low voltage capacitor 2 includes the hydrogen reaction film 22, the low voltage capacitor 2 can suppress the generation and increase of hydrogen gas as with the medium and high voltage capacitor 2.

(3) Although the hydrogen reaction film 22 contains titanium in the embodiment, the hydrogen reaction film 22 only needs to contain a metal reacting with and bonding to hydrogen and may be a film containing a metal having a high affinity for hydrogen such as magnesium (Mg), vanadium (V), zirconium (Zr), or niobium (Nb), for example.

(4) Although the capacitor 2 is an aluminum electrolytic capacitor in which the anode foil 14 and the cathode foil 16 include an aluminum foil in the embodiment, the material of the anode foil 14 and the cathode foil 16 is not limited to the aluminum foil. For example, the capacitor may be a tantalum electrolytic capacitor using tantalum for an anode.

### Examples 1 and 2

Capacitors of Examples 1 and 2 have the same configuration as the capacitor 2 described in the embodiment. The capacitors of Examples 1 and 2 have the Ti adhesion amount, the film withstand voltage Vt, the withstand voltage ratio, the capacitance C, and the capacitance percentage set to values shown in Table 1.

Capacitors of Basic Example, Reference Example 1, and Reference Example 2 have the Ti adhesion amount, the film withstand voltage Vt, the withstand voltage ratio, the capacitance C, and the capacitance percentage set to values shown in Table 1. The Ti adhesion amount of the capacitors of Basic Example, Reference Example 1, and Reference Example 2 is 0 [g/m²], and the capacitors of Basic Example, Reference Example 1, and Reference Example 2 do not include the hydrogen reaction film 22.

The capacitors of Basic Example, Example 1, Example 2, Reference Example 1, and Reference Example 2 (hereinafter referred to as a “first example group”) have the diameter of 30 [mm], the height of 40 [mm], and the rated voltage (WV) of 450 [V]. The capacitance percentage of the capacitors of the first example group is a percentage of the capacitance C of each of the capacitors of the first example group when the capacitance C of Basic Example is 100 [%].

TABLE 1

| | Ti | FILM | | | |
|---|---|---|---|---|---|
| | ADHESION | WITHSTAND | WITHSTAND | | |
| | AMOUNT | VOLTAGE | VOLTAGE | | CAPACITANCE |
| | [g/m²] | (Vt) [V] | RATIO | CAPACITANCE | PERCENTAGE |
| | (CATHODE FOIL) | (ANODE FOIL) | (Vt/WV) | [μF] | [%] |
| BASIC | 0 | 633.6 | 1.408 | 390 | 100 |
| EXAMPLE | | | | | |
| EXAMPLE 1 | 1.3 | 619.7 | 1.377 | 430 | 110 |
| REFERENCE | 0 | 619.7 | 1.377 | 430 | 110 |
| EXAMPLE 1 | | | | | |
| EXAMPLE 2 | 4.4 | 592.2 | 1.316 | 440 | 113 |
| REFERENCE | 0 | 592.2 | 1.316 | 440 | 113 |
| EXAMPLE 2 | | | | | |

[Life Check Test]

The rated voltage of 450 [V] was applied at 105 [° C.] to the capacitors of the first example group to check the operation time of the capacitors of the first example group, i.e., the time from the start of application of the rated voltage until the actuation of the pressure valve. Table 2 shows the operation time in the first example group.

TABLE 2

| | OPERATION TIME [h] |
|---|---|
| BASIC EXAMPLE | 2000 |
| EXAMPLE 1 | 2000 |
| REFERENCE | 1000 |
| EXAMPLE 1 | |
| EXAMPLE 2 | 2000 |
| REFERENCE | 500 |
| EXAMPLE 2 | |

When the film withstand voltage Vt of the anode foil is simply lowered to 619.7 [V] as shown in Reference Example 1 so as to increase the capacitance C from 390 [μF] of Basic Example to 430 [μF], the internal pressure more rapidly rises due to the generation of the molecular hydrogen, and the operation time is shortened to 1,000 hours. However, as shown in Example 1, titanium of an amount (1.3 [g/m²]) calculated based on the withstand voltage ratio described above is adhered to the cathode foil in accordance with a reduction in the film withstand voltage Vt of the anode foil, so that the capacitance C of 430 [μF] can be obtained while the operation time (2,000 hours) equivalent to Basic Example is maintained.

When the film withstand voltage Vt of the anode foil is simply lowered to 592.2 [V] as shown in Reference Example 2 so as to increase the capacitance C from 390 [μF] of Basic Example to 440 [μF], the internal pressure more rapidly rises due to the generation of the molecular hydrogen, and the operation time is shortened to 500 hours. However, as shown in Example 2, titanium of an amount (4.4 [g/m²]) calculated based on the withstand voltage ratio described above is adhered to the cathode foil in accordance with a reduction in the film withstand voltage Vt of the anode foil, so that the capacitance C of 440 [μF] can be obtained while the operation time (2,000 hours) equivalent to Basic Example is maintained.

### Examples 3 to 6

Capacitors of Examples 3 to 6 have the same configuration as the capacitor 2 described in the embodiment. The capacitors of Examples 3 to 6 have the Ti adhesion amount, the film withstand voltage Vt, the withstand voltage ratio, and the operation time set to values shown in Table 3.

Capacitors of Reference Examples 3 to 5 have the Ti adhesion amount, the film withstand voltage Vt, the withstand voltage ratio, and the operation time set to values shown in Table 3. The Ti adhesion amount of the Reference Examples 3 to 5 is 0 [g/m²], and the capacitors of Reference Examples 3 to 5 do not include the hydrogen reaction film 22.

The capacitors of Examples 3 to 6 and Reference Examples 3 to 5 (hereinafter referred to as a “second example group”) have the diameter of 30 [mm], the height of 40 [mm], and the rated voltage (WV) of 450 [V].

TABLE 3

| | Ti | FILM | | |
|---|---|---|---|---|
| | ADHESION | WITHSTAND | WITHSTAND | |
| | AMOUNT | VOLTAGE | VOLTAGE | OPERATION |
| | [g/m²] | (Vt) [V] | RATIO | TIME |
| | (CATHODE FOIL) | (ANODE FOIL) | (Vt/WV) | [h] |
| REFERENCE | 0 | 592.1 | 1.316 | 500 |
| EXAMPLE 3 | | | | |
| REFERENCE | 0 | 633.4 | 1.408 | 2000 |
| EXAMPLE 4 | | | | |
| REFERENCE | 0 | 656.4 | 1.459 | 4000 |
| EXAMPLE 5 | | | | |
| EXAMPLE 3 | 1.3 | 619.7 | 1.377 | 2000 |
| EXAMPLE 4 | 1.3 | 638.0 | 1.418 | 4000 |
| EXAMPLE 5 | 4.4 | 592.1 | 1.310 | 2000 |
| EXAMPLE 6 | 4.4 | 610.5 | 1.357 | 4000 |

[Change in Capacitor Height]

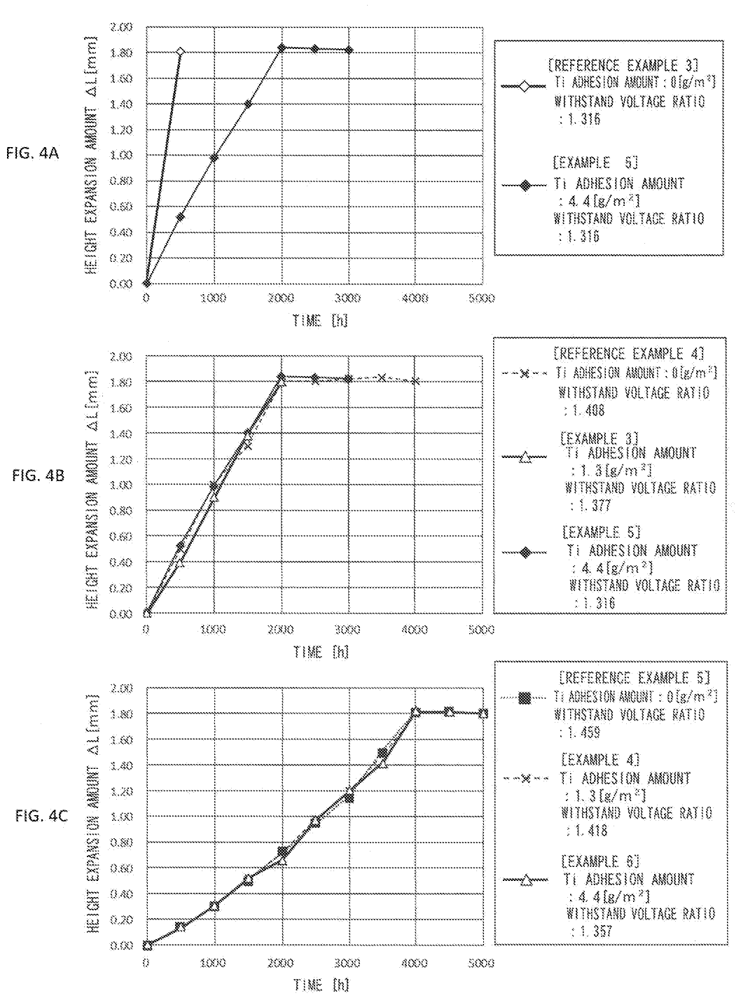

The rated voltage of 450 [V] was applied at 105 [° C.] to the capacitors of the second example group so that bottom surfaces of the capacitor were expanded in a height direction of the capacitors, i.e., in a direction along a line connecting the opening portion and the bottom surface of the outer case 4, so as to check a change in the capacitor height due to the expansion. FIG. 4A shows an expansion amount of height (height expansion amount ΔL) due to expansion of the bottom surfaces of the capacitors of Example 5 and Reference Example 3. The capacitors of Example 5 and Reference Example 3 have the same withstand voltage ratio of 1.316. However, the height expansion amount ΔL of Example 5 having the Ti adhesion amount of 4.4 [g/m²] is smaller than the height expansion amount ΔL of Reference Example 3 at the same time point. As a result, the height expansion amount ΔL of Example 5 reaches 1.8 [mm] or more in about 2000 hours, while the height expansion amount ΔL of Reference Example 3 is 1.8 [mm] or more in about 500 hours. The pressure valves of the capacitors of the second example group are set to operate and open when the height expansion amount ΔL reaches approximately 1.8 [mm]. Therefore, the operation time of the capacitor of Example 5 is made longer by 1500 hours due to the hydrogen reaction film 22 of 4.4 [g/m²] as compared to the operation time of the capacitor of Reference Example 3.

FIG. 4B shows an example of capacitors having the operation time of 2000 hours. The height expansion amounts ΔL of Example 3, Example 5 and Reference Example 4 change in substantially the same manner and reach 1.8 [mm] in about 2000 hours. From the changes in height in Example 3, Example 5, and Reference Example 4, it can be seen that the withstand voltage ratio decreases as the Ti adhesion amount increases in the capacitors having the height expansion amount ΔL changing in the same manner.

FIG. 4C shows an example of capacitors having the operation time of 4000 hours. As with the example of the capacitors having the operation time of 2000 hours, the height expansion amounts ΔL of Example 4, Example 6, and Reference Example 5 changes in substantially the same manner. From the changes in outer diameter of Example 4, Example 6, and Reference Example 5, it can be seen that the withstand voltage ratio decreases as the Ti adhesion amount increases in the capacitors having the height expansion amount ΔL changing in the same manner.

As described above, the most preferable embodiments and examples etc. of the techniques of the present disclosure have been described; however, the techniques of the present disclosure are not limited to the above description and can variously be modified and altered by those skilled in the art based on the spirit of the invention described in claims or disclosed in the description, and these modifications and alterations naturally fall within the scope of the present invention.

### INDUSTRIAL APPLICABILITY

The techniques of the present disclosure can be used as a power source circuit, an inverter, or an in-vehicle capacitor, or a method for producing the same, for example.

### REFERENCE SIGNS LIST

2 capacitor
4 outer case
5 storage part
6 capacitor element
8 sealing body
9 pressure valve
10 crimping part
12A, 12B external terminal
14 anode foil
16 cathode foil
18 separator
20 oxide film
22 hydrogen reaction film
30 vacuum vessel
32 roll
34 reversing part
24-1, 34-2 reversing roll
36 take-up roll
38-1, 38-2 evaporation source
40 film forming material

1. A capacitor comprising:
a capacitor element formed by winding an anode foil and a cathode foil; and
an outer case storing the capacitor element therein, wherein
a hydrogen reaction film reactive with atomic hydrogen generated in the outer case is formed on a surface of the cathode foil.

2. The capacitor according to claim 1, wherein the anode foil is a middle and high voltage anode foil including tunnel-shaped pits.

3. The capacitor according to claim 1, wherein the hydrogen reaction film contains titanium, and wherein the titanium reacts with the atomic hydrogen.

4. The capacitor according to claim 3, wherein a relationship between a withstand voltage ratio of the anode foil and a titanium adhesion amount of the cathode foil is within a range represented by the following equation:
$$y \geq a x + 1.326 \times {1.03}^{( \frac{T - 85}{20} )} \times exp \{ ln ( \frac{L}{2000} ) \times 0.04264 \} \qquad [ Mathematical 1 ]$$
where y is the withstand voltage ratio and is a film withstand voltage per volt of rated voltage of the capacitor,
x is the titanium adhesion amount, is an amount of titanium (unit: g/m²) contained in the hydrogen reaction film formed on the cathode foil per square meter, and is larger than 0,
a is −0.021 or −0.020,
T is an upper limit operation temperature (unit: ° C.) of the capacitor, and
L is an operation time (unit: h) of the capacitor.

5. A method for producing a capacitor comprising:
forming a hydrogen reaction film reactive with atomic hydrogen on a surface of a cathode foil;
forming a capacitor element by winding an anode foil and the cathode foil; and
storing the capacitor element in an outer case.

6. The capacitor according to claim 2, wherein the hydrogen reaction film contains titanium, and wherein the titanium reacts with the atomic hydrogen.

7. The capacitor according to claim 6, wherein a relationship between a withstand voltage ratio of the anode foil and a titanium adhesion amount of the cathode foil is within a range represented by the following equation:
$$y \geq a x + 1.326 \times {1.03}^{( \frac{T - 85}{20} )} \times exp \{ ln ( \frac{L}{2000} ) \times 0.04264 \} \qquad [ Mathematical 1 ]$$
where y is the withstand voltage ratio and is a film withstand voltage per volt of rated voltage of the capacitor,
x is the titanium adhesion amount, is an amount of titanium (unit: g/m²) contained in the hydrogen reaction film formed on the cathode foil per square meter, and is larger than 0,
a is −0.021 or −0.020,
T is an upper limit operation temperature (unit: ° C.) of the capacitor, and
L is an operation time (unit: h) of the capacitor.
